(19) United States
(12) Patent Application Publication
(10) Pub. No.: US 2008/0000724 A1
(43) Pub. Date: Jan. 3, 2008

(54) Drain Valve

(76) Inventors: William G. Stlaske, Crystal Lake, IL (US); James D. Jones, Barrington, IL (US); Glenn G. Heavens, Cheshire, CT (US); Jason Holt, St Charles, IL (US); Albert V. Boven, Barrington, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/796,772

(22) Filed: Apr. 30, 2007

Related U.S. Application Data
(60) Provisional application No. 60/817,432, filed on Jun. 29, 2006.

(51) Int. Cl. F16C 3/14

(52) U.S. Cl. 184/1.5

(57) ABSTRACT

A drain valve for an oil pan of a vehicle lubrication system includes an aperture and a drain plug. The drain plug is rotatable relative to the aperture between closed and opened positions with less than a full rotation of the plug. The plug remains secured to the aperture even when the valve is opened.

### CROSS-REFERENCE TO RELATED APPLICATIONS

The present regular U.S. patent application claims the benefits of U.S. Provisional Application Ser. No. 60/817,432; filed on Jun. 29, 2006.

### FIELD OF THE INVENTION

The present invention relates generally to drain valves, and, more particularly, the present invention pertains to oil pan drain valves for motor vehicle engine lubrication systems.

### BACKGROUND OF THE INVENTION

Automobile engine lubrication systems include an oil reservoir, often referred to as an oil pan, that holds a volume of oil which is picked up and circulated through the vehicle engine by a circulating pump and oil pickup assembly. Filters and screens are provided for removing contaminants from the oil, but over time the oil accumulates small contaminants that aren't removed. As a result, routine engine maintenance includes frequent, periodic oil changes during which the used oil is drained and replaced for better lubrication performance.

It is known to provide the oil pan at the lowest point in the lubrication system, with a drain outlet at the lowest point of the oil pan so that the lubrication system can be drained from the oil pan outlet. It is known to provide a removable plug in the oil pan drain outlet so that removing the plug allows the system to drain. In earlier known constructions, oil pans have been made of metal, with a threaded hole and a threaded metal oil plug that is simply turned into and out of the hole as needed. A seal is provided on the plug to provide a tight seal and prevent leakage.

While oil pans, drain plugs and threaded interrelationships therebetween have been used effectively for many years, they are not without drawbacks. For example, when the plug is removed from the drain outlet, it can be lost or misplaced. While a maintenance garage or service facility can have replacement plugs readily available, changing the oil in a lubrication system is a project that is often handled by the vehicle owners. A lost or misplaced oil plug can be problematic in that the typical vehicle owner will not have suitable replacement plugs handy. Traveling to a parts store for a replacement plug can be both inconvenient and time consuming, since the vehicle cannot be operated without the drain plug in place.

Over time, the threads in the drain outlet or on the plug can be damaged from repeated use, over-tightening, misaligned threading and wear from dirt and grime on the threads. Wear in the threads of the outlet and/or the plug can result in oil leakage.

With the desire of vehicle manufactures to reduce the costs of materials used in automobiles, and the desire to reduce the weight of automobiles to improve operating efficiency and fuel mileage, oil tank structures have changed.

Lightweight, thinner metals are now used with greater frequency. A sufficient thread length must be provided for adequate engagement and tightening of the drain plug therein. Inserts, bosses or other enlarged formations are used to provide the required length. Further, alternative materials are being used, including various plastics which may not thread well and which may not respond well to frequent threading into and out of by the drain plug. Brass inserts can be used but may allow oil to seep through welded regions and may not be cost-effective. Plastic threaded plugs can be over torqued easily, or otherwise damaged, and may be replaced by metal plugs during oil changes causing increased where in the threads of the drain outlet. Accordingly, sealing the oil drain outlet in plastic oil pans has presented difficulties

Other disadvantages of common threaded drain plugs and drain holes include difficulty in removing the drain plug if overly tightened and potential damage to the plug and/or the threads in the oil pan if tightened excessively. While the plug can be replaced inexpensively, if the threads in the oil pan are damaged repair or replacement can be more costly and time consuming.

### SUMMARY OF THE INVENTION

The present invention provides a drain valve for motor vehicle oil pans and the like which includes a cooperative association of an aperture in the oil pan and a drain plug received in the aperture. The drain plug is configured to loosen and engage with less than a full rotation, and is configured to be held within the aperture even when loosened and while permitting oil drainage past the plug.

In one aspect thereof, the present invention provides an oil pan drain valve with an aperture defining a hole extending therethrough and a drain plug including a head and a body extending away from the head and into the hole. The drain plug is disposed in the hole and is rotatable and axially movable between closed and opened positions relative to the aperture. The drain plug includes a retention tab near an inner end thereof engaging the aperture with the drain plug in the opened position, for limiting the drain plug axial movement relative to the aperture. One of the drain plug and the aperture defines a cam track and the other of the drain plug and the aperture defines a cam body traversing the cam track upon rotation of the drain plug relative to the aperture between the closed and opened positions. A seal is disposed between the aperture and the drain plug with the drain plug in the closed position.

In another aspect thereof, the present invention provides an oil pan drain valve with an aperture defining a hole extending therethrough, and a plurality of nibs extending into the hole. A drain plug includes a head and a body extending away from the head and into the hole. The body has an open distal end and is substantially hollow. The body defines a plurality of substantially J-shaped channels each having a substantially axial segment and a substantially circumferential segment. The drain plug is disposed in the hole with the nibs disposed in the channels, and the plug is rotatable and axially movable relative to the aperture between closed and opened positions. The drain plug includes a plurality of retention tabs near the distal end thereof engaging the aperture with the drain plug in the opened position for limiting the drain plug axial movement relative to the aperture. A seal is disposed between the aperture and the drain plug with the drain plug in the closed position.

In still another aspect thereof, the present invention provides an oil pan drain valve with an aperture defining a noncircular hole extending therethrough and first and second cam tracks on opposite sides of the hole, each including a lead-in barrier and a stop spaced from one another. A drain plug includes a head and a rectangular body having opposed sides and opposed ends, the body extending away from the head and into the hole. The body has cam bodies on the ends each including an angular lead-in surface, an angular lead-out surface and a cam crown disposed therebetween. The drain plug body extends into the hole and includes a plurality of retention tabs near a distal end thereof. The retention tabs engage the aperture with the drain plug in the opened position for limiting axial movement of the drain plug axially relative to the aperture. A seal is disposed between the aperture and the drain plug with the drain plug in the closed position.

In yet another aspect thereof, the present invention provides an oil pan drain plug with a head and a body extending away from the head. The body has an open distal end and is substantially hollow. A plurality of substantially J-shaped channels is disposed in the body, and each channel has a substantially axial segment and a substantially circumferential segment. A plurality of deflectable retention tabs near the distal end of the body project angularly outwardly from the body.

In still another aspect thereof, the present invention provides an oil pan drain plug with a head and a rectangular body having opposed sides and opposed ends. The body extends away from the head. A cam body is disposed on each of the ends. Each cam body includes an angular lead-in surface, an angular lead-out surface and a cam crown disposed therebetween. A deflectable retention tab is disposed on each end. Each retention tab projects angularly outward from the end.

An advantage of the present invention, in one aspect thereof, is providing a drain valve for motor vehicle oil pans that can be used in stamped metal oil pans, cast aluminum oil pans and molded oil pans made of plastics or other materials as stamped, as cast or as molded, without the need for secondary operations to adapt the oil pan once provided.

Another advantage of the present invention, in another aspect thereof, is providing an oil pan drain valve that includes a drain plug that can be opened and closed with less than one full rotation, and that remains secured to a drain aperture even when loosened and while allowing oil flow from the oil pan, yet can be removed and replaced if necessary.

Yet another advantage of the present invention, in yet another aspect thereof, is providing a drain valve for oil pans that is not damaged by over tightening.

A still further advantage of the present invention in a still further aspect thereof is providing a drain valve for a motor vehicle oil pan that can be unseated easily to initiate drainage, and that can be configured for controlling and directing the direction of oil flow from the oil pan at an acceptable flow rate.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a fragmentary perspective view of an oil pan and drain valve in accordance with the present invention;

FIG. 2 is a perspective view of the oil pan and drain valve shown in FIG. 1, but shown from a different angle;

FIG. 3 is an elevational view of the oil pan and drain valve shown in FIGS. 1 and 2, but showing the valve in an opened position;

FIG. 4 is a perspective view of the plug for the drain valve shown in the preceding drawings;

FIG. 5 is a plan view of the aperture for the valve shown in the previous drawings;

FIG. 6 is a cross-sectional view of the seal shown in FIGS. 2-4;

FIG. 7 is an exploded perspective view of a drain valve in accordance with a second embodiment of the present invention;

FIG. 8 is a perspective view of the assembled drain valve shown in FIG. 7;

FIG. 9 is a perspective view of the valve shown in FIGS. 7 and 8, illustrating the valve opened but in an initial stage of closing;

FIG. 10 is a perspective view of the valve shown in FIGS. 7-9 illustrating the valve in a further position toward closing;

FIG. 11 is a perspective view of the valve shown in FIGS. 7-10, illustrating the valve in a fully closed position;

FIG. 12 is a perspective view showing a further embodiment for an aperture in a valve of the present invention;

FIG. 13 is a perspective view of yet another embodiment for an aperture and a valve of the present invention;

FIG. 14 is a perspective view of still another embodiment for a drain valve of the present invention, with the drain valve shown in a closed position; and

FIG. 15 is a perspective view of the drain valve shown in FIG. 14, but illustrating the valve at an initial stage of opening.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

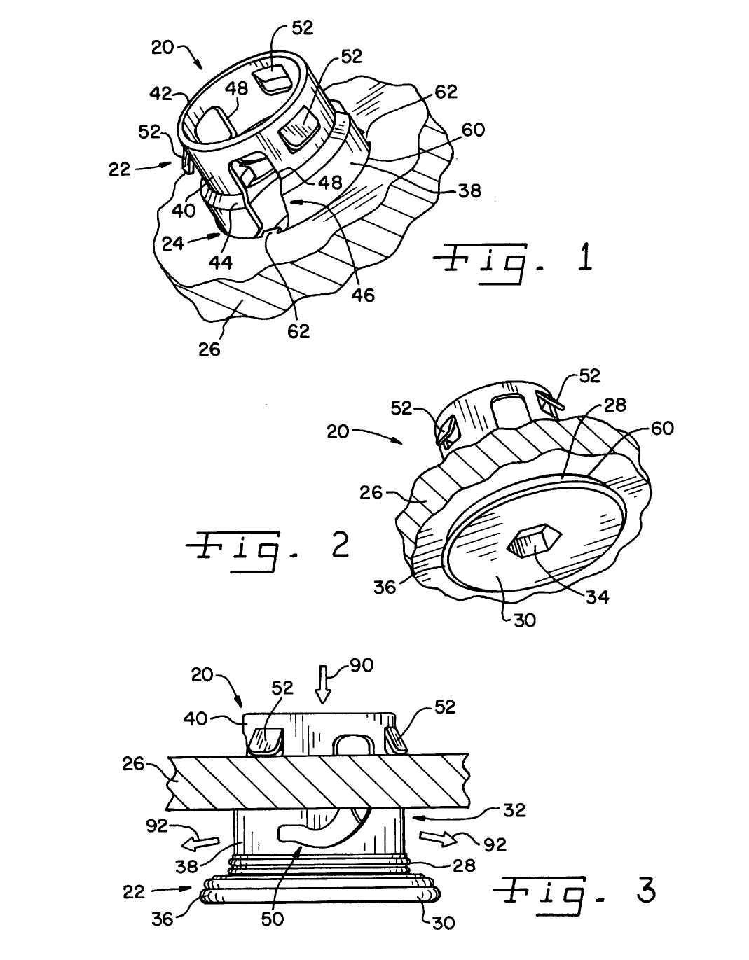

Referring now more specifically to the drawings and to FIGS. 1, 2 and 3 in particular, a drain valve 20 in accordance with the present invention is shown. Drain valve 20 includes a plug 22, an aperture 24 provided in an oil pan 26 and a seal 28 disposed between plug 22 and aperture 24. Plug 22 and aperture 24 can be made out of various materials suitable for the application, including metals and plastics. Plug 22 and aperture 24 can be of the same material or can be of different materials.

Plug 22 includes a head 30 and a body 32 extending from one side of head 30. Head 30 defines a tool receiver 34, which in the exemplary embodiment is in the form of a hex-shaped cavity 34 for receiving a driving tool to rotate plug 22 relative to aperture 24. It should be understood that tool receiver 34 in the nature of a cavity 34 as shown for the exemplary embodiment can be cavities of other shapes for receiving other types of tools, including various sizes and styles of male drivers. Further, in the exemplary embodiment, head 30 has a substantially round peripheral surface 36; however, it should be understood that other shapes for head 30 and peripheral surface 36 thereof also can be used. For example, head 30 can have a six-sided peripheral surface for receiving a wrench thereon with or without a cavity tool receiver 34. Thus, the peripheral surface of head 30 can be the tool receiver such as for receiving open-end or box-end wrenches, sockets and the like. However, a low overall profile for head 30 can be maintained if tool receiver 34 embodies a cavity as shown. A low profile can be advantageous to provide increased ground clearance when the oil pan is provided at the bottom of the motor vehicle near the ground clearance level.

Body 32 is a substantially hollow cylindrical structure extending axially from head 30 on a side of head 30 opposite tool receiver 34. In the exemplary embodiment, body 32 includes a proximal portion 38 adjacent head 30 and a distal portion 40. Distal portion 40 defines an open end 42, with the opening therefrom extending through distal portion 40 and proximal portion 38 to head 30. Proximal portion 38 is of larger diameter than distal portion 40, and a tapered shoulder 44 is defined between proximal portion 38 and distal portion 40.

A plurality of J-shaped cam tracks 46 are provided in body 32, with three such J-shaped cam tracks 46 being illustrated in the exemplary embodiment. More than three cam tracks 46 or less than three cam tracks 46 also can be used. Each J-shaped cam track 46 is a channel cut into body 32 and includes a substantially axial segment 48 having an end near open end 42 and merging into a substantially circumferential segment 50 near head 30. Accordingly, J-shaped cam tracks 46 extend through both proximal portion 38 and distal portion 40.

Outwardly angled deflectable retention tabs 52 are provided in distal portion 40, with three such retention tabs 52 being shown in the exemplary embodiment near open end 42. As illustrated for the exemplary embodiment, retention tabs 52 are alternately located with cam tracks 46 so that three retention tabs 52 are used. However, it should be understood that more or fewer retention tabs 52 can be used, and the retention tabs can be provided in different positional relationships relative to cam tracks 46. Retention tabs 52 are cutouts of distal portion 40, with a secured edge near open end 42 and angling outwardly from distal portion 40 in a direction toward head 30.

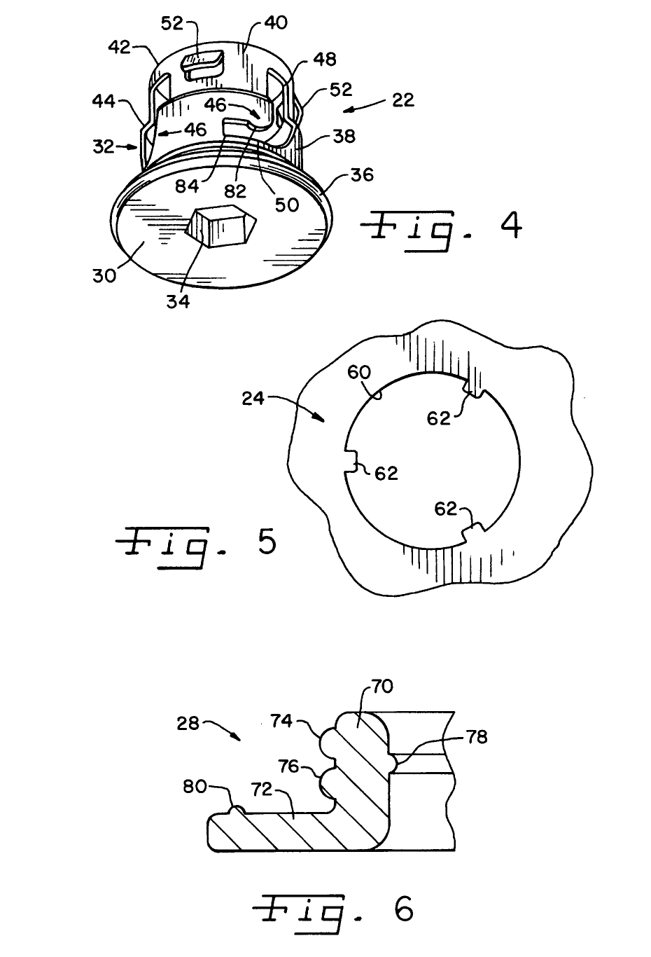

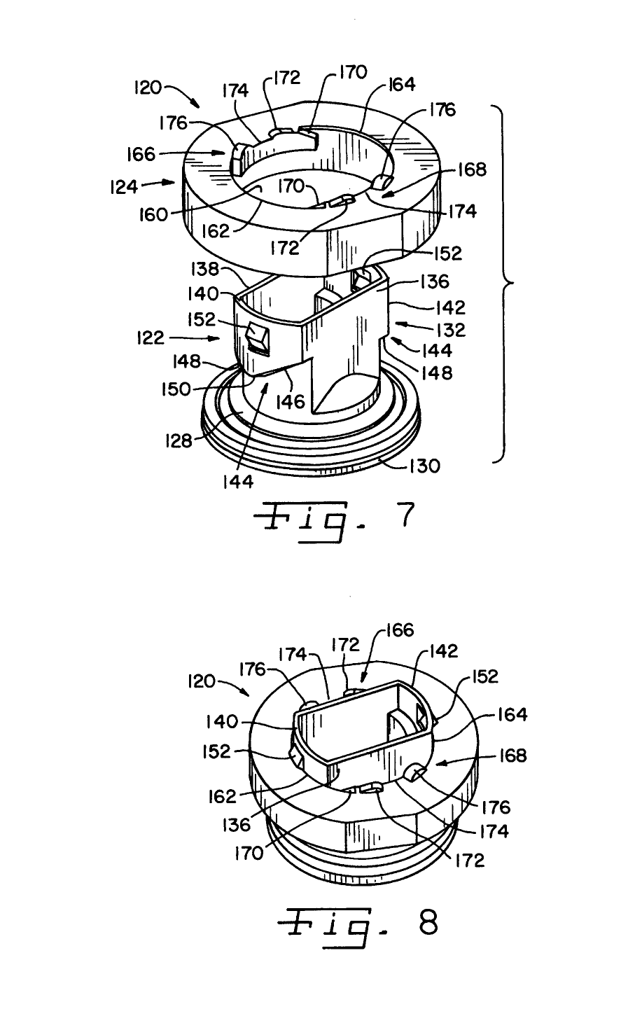

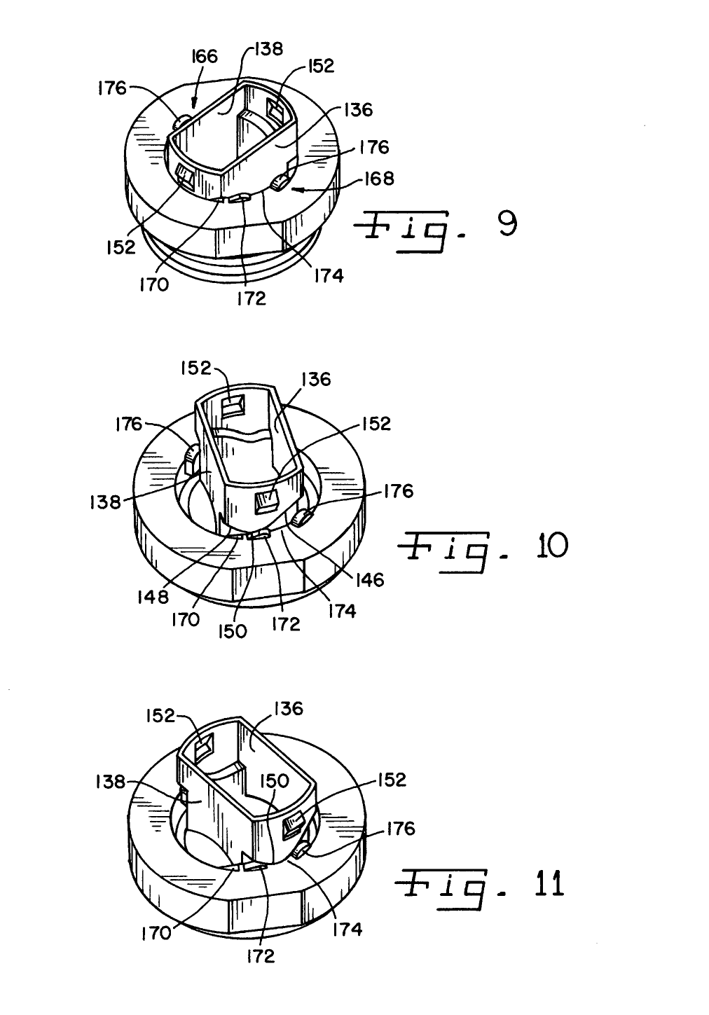

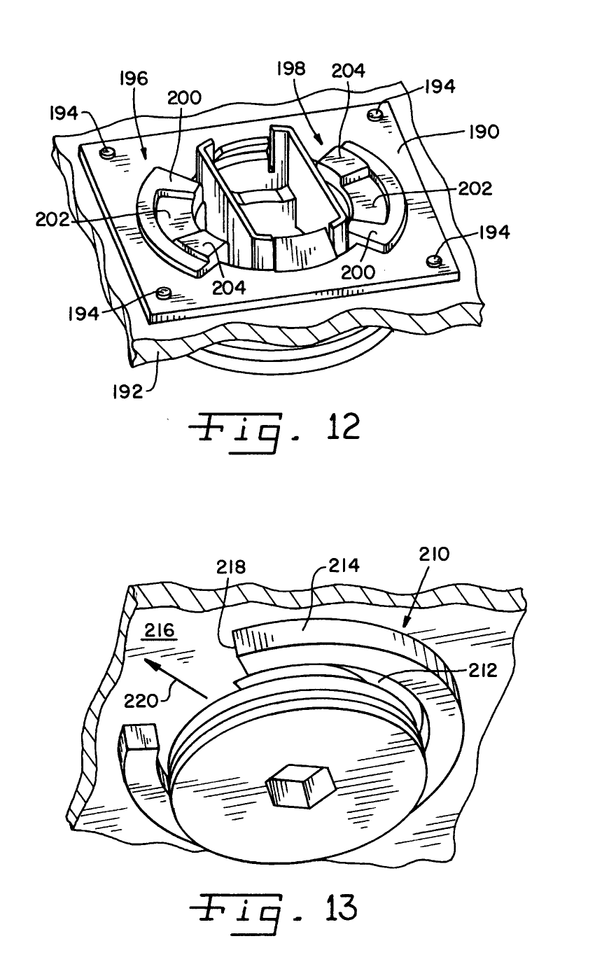

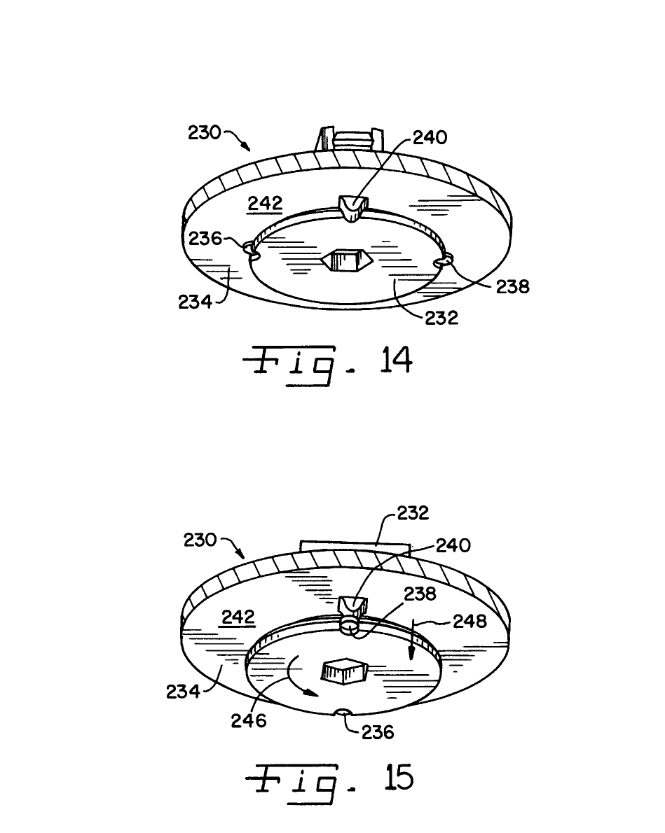

Aperture 24 is provided in oil pan 26, and in the exemplary embodiment shown in FIGS. 1-5 aperture 24 is configured in the material of oil pan 26, such as by stamping, casting, molding or the like simultaneously with the formation of oil pan 26. Accordingly, aperture 24 is formed without additional steps or procedures being required being required. Aperture 24 includes a hole or opening 60 which extends between the interior volume of oil pan 26 and the ambient environment of oil pan 26. Aperture 24 further defines a plurality of cam bodies 62 in the form of nibs projecting into hole or opening 60, and in the exemplary embodiment being described aperture 24 is provided with three cam bodies 62. Plug 22 is received in and operationally disposed relative to aperture 24, with cam bodies 62 being disposed in cam tracks 46.

Seal 28 is a pliable body for sealing the space between plug 22 and aperture 24 when valve 20 is in a closed position. Seal 28 is configured to provide a barrier between head 30 and the outer surface of aperture 24 and between body 32 and the surface defining hole 60. Accordingly, as best seen in FIG. 6, seal 28 includes an annular portion 70 received in hole 60 and against proximal portion 38 of body 32. Seal 28 further includes a radial flange portion 72 extending outwardly from annular portion 70 and disposed between head 32 and the outer surface of aperture 24 adjacent hole 60. Deflectable or compressible protrusions 74, 76 are provided on an outer surface of annular portion 70 for engagement against the surface defining hole 60. A further protrusion 78 is provided on the inside surface of annular portion 70 for engaging proximal portion 38, between head 30 and circumferential segments 50 of cam tracks 46. A still further protrusion 80 is provided on radial flange portion 72 for engaging against the surface of aperture 24 immediately adjacent hole 60. Accordingly, protrusions 74, 76, 78 and 80 provide barriers against migration of fluids into or out of oil pan 26 when plug 22 is seated in aperture 24.

Valve 20 is assembled by placing seal 28 on body 32 and against the inside surface of head 30. Distal portion 40 of body 32 is positioned in hole 60 of aperture 24, with J-shaped cam tracks 46 substantially aligned with cam bodies 62. Plug 22 is pressed into aperture 24. Retention tabs 52 deflect inwardly as each passes through hole 60, and tabs 52 rebound outwardly after completely passing through hole 60. Retention tabs 52 define a diameter at their free outer edges that is greater than the diameter of hole 60, so that plug 22 is not easily removed from aperture 24 after tabs 52 have been forced through hole 60 during installation.

With cam bodies 62 disposed in cam tracks 46, plug 22 can move axially relative to aperture 24 while cam bodies 62 traverse axial segments 48 of tracks 46. As head 30 approaches aperture 24, with rotation of head 30 cam bodies 62 follow circumferential segments 50 of cam tracks 46. Maximum compression of radial flange portion 72 of seal 28 is achieved before full rotation of plug 22. Accordingly, ramps 82 are defined in circumferential segments 50 which when engaged with cam bodies 62 provide maximum compression of radial flange portion 72. Upon tightening, as cam bodies 62 pass ramps 82 a slight “snapped in” sensation is experienced as cam bodies 62 settle into end segments 84 of cam tracks 46. Upon loosening, ramps 82 provide increased compression of seal 28, such that when cam bodies 62 rotate past ramps 82 and into axial segments 48 of tracks 46, the rebound from seal 28 initiates loosening and unsealing of seal 28 relative to body 22 and aperture 24. In the exemplary embodiment, adjusting plug 22 between fully closed and fully opened positions requires only about one-fourth of a full rotation of plug 22. By extending and adjusting the length and orientation of cam tracks 46 the required degree of rotation to move plug 22 between the fully closed and fully opened positions can be altered.

With valve 20 in an opened position as shown in FIG. 3, oil from within oil pan 26 flows out of oil pan 26 by flowing into body 32 via open end 42 (as indicated by arrow 90) and out of body 32 via the exposed portions of tracks 46 outwardly of oil pan 26 (as indicated by arrows 92). Further, oil can flow through hole 60 along the outer surfaces of distal portion 40 and proximal portion 38 to ambient areas relative to pan 26, such as a suitable used oil receptacle (not shown).

FIGS. 7-11 illustrate another embodiment of the present invention. Drain valve 120 includes a plug 122 and an aperture 124. A seal 128 is provided between plug 122 and aperture 124. Plug 122 is configured to be received and operate in aperture 124. Seal 128, which is configured similarly to seal 28, inhibits the migration of fluid between plug 122 and aperture 124.

Plug 122 includes a head 130 and a body 132. Head 130 can be configured similarly to head 30, including having a tool receiver 34 and/or a head peripheral surface configured for receiving and engaging a hand tool for rotating plug 130.

Body 132 is rectangular in configuration, having longer, substantially flat sides 136, 138. Ends 140, 142 extend between sides 136, 138. Each end 140, 142 defines a similarly shaped outwardly extending cam body 144 including an angular lead-in surface 146 and an angular lead-out surface 148 converging at a cam crown 150. Lead-in surface 146 and lead-out surface 148 each angle from cam crown 150 away from head 130. A deflectable retention tab 152 is provided in each cam body 144.

Aperture 124 defines a hole or opening 160 that is substantially oval, having rounded ends 162, 164 on a major axis of opening 160 and cam tracks 166, 168 on the minor axis of opening 160. Each cam track 166, 168 includes an angular lead-in ramp 170, a lead-in barrier 172, a lock surface 174 and a stop 176 spaced from lead-in barrier 172 by the length of lock surface 174. Lead-in barrier 172 is provided at the end of lead-in ramp 170 and is in the nature of a rounded protrusion providing increased resistance to an object sliding along lead-in ramp 170. Stop 176 is a similar but more abrupt protrusion inhibiting sliding engagement with a surface sliding along a lock surface 174.

Valve 120 is assembled by positioning body 132 in hole 160 of aperture 124, with cam bodies 144 positioned substantially aligned with rounded ends 162, 164. Retention tabs 152 deflect inwardly as each passes through hole 160 along rounded ends 162, 164. Tabs 152 rebound outwardly after completely passing through hole 160. Retention tabs 152 define a diameter at their outer edges greater than the major axis of hole 160 so that plug 130 is not easily removed from aperture 124 after tabs 152 have been forced through hole 160 during installation. FIG. 8 illustrates the installed and assembled position of plug 122 in aperture 124, with retention tabs 152 engaged on an inner surface of aperture 124.

Valve 120 is closed by being pushed inwardly from the position illustrated in FIG. 8, and then rotated so that lead-in surface 146 of each cam body 144 slides along the associated lead-in ramp 170 and over lead-in barrier 172. As cam crown 150 passes lead-in barrier 172, seal 128 is at the point of maximum compression, and an increased resistance is detected by the person rotating plug 122. The “lock-in” sensation is felt as cam crown 150 settles onto lock surface 174, between lead-in barrier 172 and stop 176. Significant resistance is sensed if plug 122 continues to be rotated, thus inhibiting over tightening. However, even if undue force is exerted and cam crown 150 is forced over stop 176 neither plug 122 nor aperture 124 will be damaged in that cam crown 150 after passing over stop 176 merely enters the area of rounded end 162 or 164, whereby plug 122 can move axially outward.

From a locked position with cam crowns 150 disposed along lock surfaces 174, valve 120 is opened by rotating plug 122 in a reverse direction. Lead-out surface 148 of each cam body 144 slides up and over the lead-in barrier 172 associated with it until cam crown 150 passes over lead-in barrier 172. Again, as cam crowns 150 pass over lead-in barriers 172, maximum compression of seal 128 occurs. The natural rebounding effect of seal 128 as cam crowns 150 clear lead-in barriers 172 causes some axial force to be applied against plug 122 in a direction to move plug 122 outwardly relative to aperture 124. Plug 122 is moved to a fully opened position by further rotation relative to aperture 124 until lead-in surfaces 146 completely clear lead-in ramps 170, such that cam bodies 144 are positioned in rounded ends 140, 142 whereby plug 122 can move fully outward relative to aperture 124. In the opened position, oil from within an oil pan flows along substantially flat sides 136, 138 between plug body 132 and hole 160. As with the previous embodiments, adjusting valve 120 between fully closed and fully opened positions requires only about one-fourth of a full rotation of body 122.

FIG. 12 illustrates a further embodiment for an aperture 190 of the present invention. Apertures 24, 124 described previously are monolithic formations of the oil pan in which they are used. Aperture 190 is a discrete body affixed to an oil pan 192 via fastenings 194, which can be mechanical fasteners, welds, adhesive or the like. Aperture 190 is a separate body subsequently installed in oil pan 192 having or defining a larger opening for receiving aperture 190. Aperture 190 can be a rectangular body, a round body or of other shapes inset into a portion of oil pan 192.

Aperture 190 defines first and second cam tracks 196, 198 which each include a lead-in barrier 200 a lock surface 202 and a stop 204. Cam tracks 196, 198 differ from cam tracks 166, 168 previously described herein in that a lead-in ramp is not provided, and cam bodies 144 merely slide over the edge of lead-in barriers 200.

FIG. 13 illustrates yet another embodiment for an aperture 210 defining a hole 212. A flow directing the wall 214 substantially surrounds hole 212 on an outer surface 216 of aperture 210, and wall 214 defines a limited outlet 218. Wall 214 directs the flow of oil from hole 212 toward outlet 218 such that a more directed and formed stream is provided through outlet 218, as indicated by arrow 220.

As described previously herein, maximum compression of seal 28 or seal 128 is achieved in advance of the closed or locked down position. Accordingly, as cam bodies 62 traverse ramps 82, 84 when rotated towards the opened position from the locked position seal 28 again is compressed beyond the compression experienced with cam bodies 62 in end segments 84. As cam bodies 62 clear ramps 82, 84 seal 28 rebounds, providing some force to break plug 22 loose from its sealed condition within aperture 24. So also, as cam crowns 150 pass lead-in barriers 172 when moving toward an opened position, a further compression of seal 128 occurs. As seal 128 rebounds after crowns 150 pass completely beyond lead-in barriers 172, some force is applied to break plug 122 loose from its sealed condition within aperture 124. In some situations it may be desirable to provide additional designed-in force to loosen a plug of the present invention from an aperture of the present invention. FIGS. 14 and 15 illustrate a still further embodiment of the present invention in which a valve 230 includes a plug 232 and an aperture 234 provided to mechanically assist withdrawing the plug from the aperture. Plug 232 is provided with coined projections 236, 238; and aperture 234 is provided with at least one bump 240 on an outer surface 242 thereof. Bump 240 is positioned to encounter one of the projections 236, 238 as plug 232 is rotated from a closed position to an opened position (as indicated by arrow 246). As projections 236, 238 encounter a bump 240, plug 232 is forced outwardly of aperture 234 (as indicated by arrow 248). The sealed condition is loosened, and plug 232 can be withdrawn easily from aperture 234, to enable the flow of fluid from valve 230.

Drain valves of the present invention can be used in oil pans of various materials and can be made of various materials. Valve components can be configured in an oil pan along with the routine stamping, casting or molding used to create the oil pan. The valves operate with the standard thickness of the oil pan along the inner and/or outer surfaces thereof. No enlargement, boss, extended insert or other mass of material is required for the valve. Accordingly, secondary operations to prepare the oil pan to accommodate the valve of the present invention are not required. Since the drain outlet can be located without a large mass of material, greater flexibility is achieved in designing the oil pan and locating the outlet. Without conventional threads, thread damage from misaligned threading is eliminated. The valve operates smoothly and easily and is not prone to damage from misuse. Although the plugs are routinely held within the aperture at all times, even when oil is being drained, if necessary a plug can be replaced by withdrawing forcefully on the plug, to cause the retention tabs to break or yield, thereby allowing full removal of the plug from the aperture. A replacement plug then can be inserted in a manner as described previously, without extended time, effort or expense. Since the plug remains secured to the oil pan and aperture even when oil is being drained, the plug cannot be misplaced and is not damaged easily while oil is being drained from the oil pan.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. An oil pan drain valve, comprising:
an aperture defining a hole extending therethrough;
a drain plug including a head and a body extending away from said head and into said hole;
said drain plug being disposed in said hole and being rotatable and axially movable between closed and opened positions relative to said aperture;
said drain plug including a retention tab near an inner end thereof engaging said aperture with said drain plug in said opened position for limiting said drain plug axial movement relative to said aperture;
one of said drain plug and said aperture defining a cam track and the other of said drain plug and said aperture defining a cam body traversing said cam track upon rotation of said drain plug relative to said aperture between said closed and opened positions; and
a seal disposed between said aperture and said drain plug with said drain plug in said closed position.

2. The drain valve of claim 1, said body defining a channel, and said aperture defining a nib extending into said channel.

3. The drain valve of claim 2, said body defining a plurality of said channels; and said aperture defining a plurality of said nibs, one said nib extending into each said channel.

4. The drain valve of claim 3, each said channel having a substantially axial segment and a substantially circumferential segment.

5. The drain valve of claim 4, said channels including an inwardly directed ramp in said substantially circumferential segments.

6. The drain valve of claim 1, said aperture defining said cam track including a lead-in barrier and a stop spaced from one another; and said cam body being disposed on said body of said plug and including a lead-in surface and a lead-out surface on opposite sides of a cam crown disposed therebetween.

7. The drain valve of claim 1, said hole being noncircular and said cam track including two said cam tracks disposed on opposite sides of said hole, each said cam track including a lead-in barrier and a stop spaced from one another; and said cam body including two said cam bodies on opposite sides of said body of said plug, each said cam body including a lead-in surface and a lead-out surface on opposite sides of a cam crown disposed therebetween.

8. The drain valve of claim 1, said seal including an annular portion disposed between said body of said plug and said hole in said aperture with said plug in said closed position, and a radial flange portion disposed between said head of said plug and said aperture with said plug in said closed position.

9. The drain valve of claim 1, said aperture defining a wall on an outer surface thereof, said wall substantially surrounding said hole and defining an outlet.

10. The drain valve of claim 1, said aperture being a monolithic formation with an oil pan.

11. The drain valve of claim 1, said aperture being a discrete body affixed to an oil pan.

12. The drain valve of claim 1, said head defining an outward projection and said aperture defining a bump on an outer surface thereof, said bump being located to engage said projection upon rotation of said plug from said closed position to said opened position.

13. An oil pan drain valve, comprising:
an aperture defining a hole extending therethrough, and a plurality of nibs extending into said hole;
a drain plug including a head and a body extending away from said head and into said hole, said body having an open distal end and being substantially hollow, said body defining a plurality of substantially J-shaped channels each having a substantially axial segment and a substantially circumferential segment;
said drain plug being disposed in said hole with said nibs disposed in said channels, and said plug being rotatable and axially movable relative to said aperture between closed and opened positions;
said drain plug including a plurality of retention tabs near said distal end thereof engaging said aperture with said drain plug in said opened position for limiting said drain plug axial movement relative to said aperture; and
a seal disposed between said aperture and said drain plug with said drain plug in said closed position.

14. The drain valve of claim 13, said seal including an annular portion disposed between said body of said plug and said hole in said aperture with said plug in said closed position, and a radial flange portion disposed between said head of said plug and said aperture with said plug in said closed position.

15. The drain valve of claim 13, said aperture defining a wall on an outer surface thereof, said wall substantially surrounding said hole and defining an outlet.

16. The drain valve of claim 13, said aperture being a monolithic formation with the oil pan.

17. The drain valve of claim 13, said aperture being a discrete body affixed to an oil pan.

18. The drain valve of claim 13, said head defining an outward projection and said aperture defining a bump on an outer surface thereof, said bump being located to engage said projection upon rotation of said plug from said closed position to said opened position.

19. An oil pan drain valve, comprising:
an aperture defining a noncircular hole extending therethrough;
first and second cam tracks on opposite sides of said hole, each including a lead-in barrier and a stop spaced from one another;
a drain plug including a head and a rectangular body having opposed sides and opposed ends, said body extending away from said head and into said hole, said body having cam bodies on said ends each including an angular lead-in surface, an angular lead-out surface and a cam crown disposed therebetween;
said drain plug body extending into said hole and including a plurality of retention tabs near a distal end thereof, said retention tabs engaging said aperture with said drain plug in said opened position for limiting axial movement of said drain plug axially relative to said aperture; and
a seal disposed between said aperture and said drain plug with said drain plug in said closed position.

20. The drain valve of claim 20, each said cam track including an angular lead-in ramp on a side of said lead-in barrier opposite said stop.

21. The drain valve of claim 19, said seal including an annular portion disposed between said body of said plug and said hole in said aperture with said plug in said closed position, and a radial flange portion disposed between said head of said plug and said aperture with said plug in said closed position.

22. The drain valve of claim 19, said aperture defining a wall on an outer surface thereof, said wall substantially surrounding said hole and defining an outlet.

23. The drain valve of claim 19, said aperture being a monolithic formation with the oil pan.

24. The drain valve of claim 19, said aperture being a discrete body affixed to an oil pan.

25. The drain valve of claim 19, said head defining an outward projection and said aperture defining a bump on an outer surface thereof, said bump being located to engage said projection upon rotation of said plug from said closed position to said opened position.

26. An oil pan drain plug, comprising:
a head;
a body extending away from said head, said body having an open distal end and being substantially hollow;
a plurality of substantially J-shaped channels each having a substantially axial segment and a substantially circumferential segment disposed in said body; and
a plurality of deflectable retention tabs near said distal end of said body projecting angularly outwardly from said body.

27. An oil pan drain plug, comprising:
a head;
a rectangular body having opposed sides and opposed ends, said body extending away from said head;
a cam body disposed on each of said ends, each said cam body including an angular lead-in surface, an angular lead-out surface and a cam crown disposed therebetween;
a deflectable retention tab disposed on each said end, each said retention tab projecting angularly outward from said end.
